(19) United States
(12) Patent Application Publication
(10) Pub. No.: US 2008/0014015 A1
(43) Pub. Date: Jan. 17, 2008

(54) Bicycle Seat Support Clamp Devise

(76) Inventor: Raymond P. Brick, Longs, SC (US)

Correspondence Address: GREENBERG & LIEBERMAN, LLC, 2141 WISCONSIN AVE, N.W., SUITE C-2, WASHINGTON, DC, 20007, US

(21) Appl. No.: 11/457,083

(22) Filed: Jul. 12, 2006

(51) Int. Cl. F16B 7/10

(52) U.S. Cl. 403/109.1

(57) ABSTRACT

An improvement in the method of securing tubes that support the seat back to the frame of the bicycle. The device is a clamp that holds the two tubes in place with bolts. This method of clamping the tubes allows the seat to be easily adjusted in any increment desired to accommodate a user of any size. It also obviates the use of pins and will save the setting of the placement of the seat, even after the seat is removed. The clamp is secured onto the small tube at a position desirable to the user and the large tube is placed over the small tube. The bolts are then tightened to lock the clamp into place. The invention applies to any bicycle and is a unique improvement on the existing methods of adjusting the height of the seat.

### FIELD OF THE INVENTION

The present invention relates to an improvement on the method of securing and adjusting the telescoping tubes to the frame that supports the seat back of a bicycle.

### BACKGROUND OF THE INVENTION

Recumbent bicycles can be used for transportation and recreation. The bicycles allow the user to be in a seated position with his or her legs extended in front of them. On most recumbent bicycles, two tubes attach to the bicycle frame to support the seat back. In order to adjust the seat to accommodate the height of each person riding the bicycle, the length of the supports can be adjusted by using two tubes of different diameters such that one tube fits inside the other tube. The usual method of adjusting and securing these tubes is to drill a series of holes in both tubes and securing them with various types of hitch pins.

There are many disadvantages to the usual method of adjusting and securing the tubes. First, when removing these pins to adjust the seat, the pins can become lost. Commonly the radial alignment of the holes in the two tubes is not perfect which makes it difficult to remove and insert the pins. Also, the adjustments are limited to pre-determined increments, being that of the drilled series of holes in each tube. And once the pins are removed and the seat is moved, the setting for the seat is lost, requiring the user to adjust the seat to his or her preference after each time the seat is moved. Some people spend a lot of time and money customizing their bicycles and want them to be aesthetically pleasing. A pin sticking out of a tube with a row of pre-drilled holes may not be aesthetically pleasing to a user who desires a more sleek or streamlined look.

Relevant art includes U.S. Pat. No. 4,167,352 issued to Pletscher on Sep. 11, 1979. It describes a cone shaped wedge for locking two tubes of a bicycle. The wedge is designed to be used preferably for clamping the steering housing tube in the steering fork tube, whereas the present invention focuses on clamping the tubes that support the seat back. There would have to be a bolt running from the end of the tube down to the wedge to put tension on it. That bolt is difficult to access when trying to adjust the tubes of the bicycle making the cone shaped wedge impractical to adapt to this use. It would also not allow the user to save the setting of the seat once it is removed. The present invention allows the user to adjust the seat in unlimited increments and because the clamp is always attached to the tube, the setting of the seat is always saved.

U.S. Pat. No. 5,419,574 issued to Krumm on May 30, 1995 is a recumbent bicycle that has many clamps connecting all of the tubes on the bicycle. The clamps, however, are not specifically designed for the seat back support tubes and do not have a slot in the middle of the clamp displaying the ends of the tubes, such as the present invention.

U.S. Pat. No. 6,074,123 issued to Osborne on Jun. 13, 2000 is a clamp used in the steering tube of a bicycle. The clamp is enclosed in the tube, so it would be more difficult to adjust the position of the tubes as opposed to the present invention where it is simple to access the clamp and adjust the tubes as desired.

U.S. Pat. No. 6,616,164 issued to Schlitter on Sep. 9, 2003 is a recumbent bicycle with a system of moving the seat along pre-drilled holes on the tube. Bolts and screws are used to hold the clamp together. The pre-drilled holes prevent the user from being able to adjust the bicycle at unlimited increments, whereas the present invention would allow for adjustments at any increment, not limited to pre-drilled holes in the tubes.

U.S. Pat. No. 6,646,219 issued to Kane and Fisher on Nov. 11, 2003 is a system of assembling a tube clamp. There are also many screws and the clamp requires a lot of assembly, putting the user at risk of losing a piece of the clamp when the seat is removed. The present invention has only a few parts that are simple to put together and would not be lost because the clamp would always be attached to the tube.

U.S. Publication Ser. No. 10/823,464 issued to Sicz and Wisseman on Oct. 21, 2004 is an adjustable bicycle seat assembly. It describes a shim with a spring that would hold the tube in place. This system would not save the seat setting once the seat is removed, whereas the present invention has a clamp that is always attached to the tube, which saves the setting of the seat once it is removed.

Hence, there is a need for an aesthetically pleasing device that will allow the seat of a recumbent bicycle to be removed without worrying about losing pins that hold the tubes in place. Adjustments should also be easily made in any increment that the user desires. Once the seat is removed, the setting should be saved so that when the seat is replaced, it will be in the same position as before it was removed.

### SUMMARY OF THE INVENTION

The present invention is an improvement upon the method of using hitch pins to secure bicycle tubes to the frame that supports the seat back. It is comprised of a left hand and a right hand clamp with two bolts for adjusting the either side of bicycle tubes. The pin holding the tubes in place is removed and the larger tube is lifted off of the smaller tube. There is a hole through the bottom of the clamp to receive the smaller tube, and a hole of a larger diameter through the top of the clamp to receive the larger tube. The clamp slides onto the smaller tube. The smaller tube is inserted at least 2 inches into the larger tube. The clamp is always kept on the smaller tube, which keeps the position of the clamps saved so that the user will not have to adjust the clamps each time the seat is removed.

The clamp slides onto the larger tube, making sure the clamp is fully seated. The clamp is fully seated when the end of the larger tube is visible through the holes in the sides of the clamp. The holes in the clamp allow the user to see where the end of the larger tube is, which is something that currently available clamps cannot accomplish. Once the tubes are in place, the user can adjust the tubes in any increment to fit the length of the user's body, using the holes to ensure that the larger tube is centered within the clamp for stability. The clamp bolts are tightened, preferably using a 3 mm Allen wrench. The steps are repeated for the other clamp.

Using the clamps allows the setting of the seat to be saved even after the seat has been removed. The clamp would remain on the smaller tube of the bicycle and once the seat is placed back onto the bicycle, the user would insert the smaller tube into the larger tube and simply tighten the clamp to hold it back into place. Because the clamp can be fixed to the smaller tube at all times, it takes away the chance that any pins or pieces of the adjustment method would be lost during a seat adjustment.

It is an object of the present invention to provide for a recumbent bicycle that is not limited in adjustment positions for the seat. This would allow the user to adjust the seat to any position they desire, without being limited to pre-determined increments.

Another object of the present invention is to obviate the need for a pin system on the seat frame, which will prevent a user from losing the pin at any time the seat is adjusted or removed from the bicycle frame.

A third object of the present invention is to obviate the need for pre-drilled holes, which may not always line up correctly when the user removes or replaces the pin.

A fourth object of the present invention is to save the setting so it does not have to be adjusted any time the seat is removed from the bicycle frame.

A fifth object of the present invention is to provide for a tube clamp, which is more aesthetically pleasing than pins that are currently used to hold these recumbent bicycle tubes together.

A sixth object of the invention is to provide the user with a view of the end of the larger tube through the clamp to ensure that it is correctly placed within the clamp.

A final object of the present invention is to have a system that is easy to use and has a low cost of manufacture, keeping the prices low for the user.

### BRIEF DESCRIPTION OF THE DRAWINGS

FIG. 1 is a side view of a recumbent bicycle with the placement of the clamps holding the seat back supports together.

FIG. 2 is a side view of the present embodiment as seen on a bicycle tube from the left side.

FIG. 3 is a bottom view of the present embodiment.

FIG. 4 is a top view of the present embodiment.

### DETAILED DESCRIPTION OF THE DRAWINGS

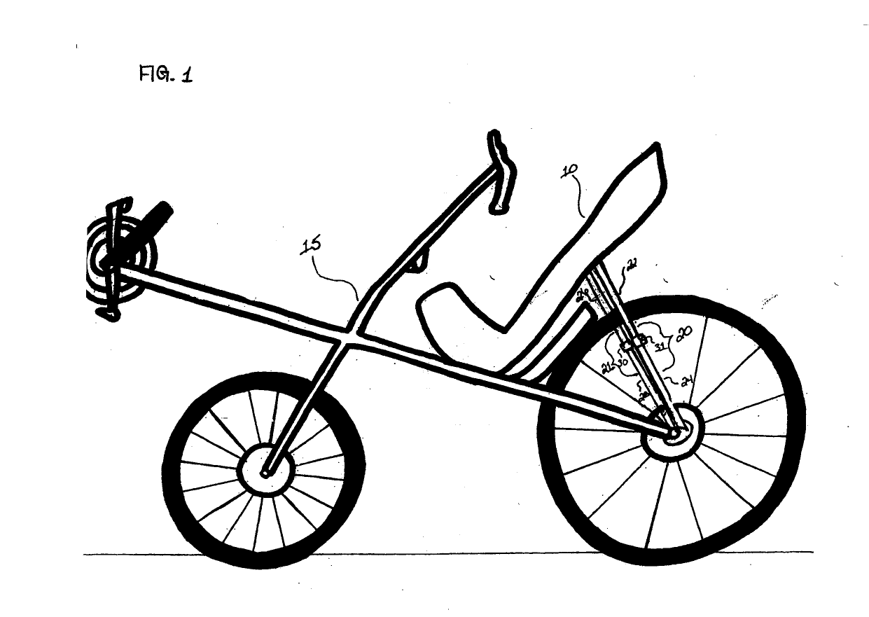

In FIG. 1, there is a standard recumbent bicycle that shows a seat 10, a frame 15, a left side seat back support 20 and a right side seat back support 21. Left side seat back support 20 and right side seatback support 21 are identical in shape and size. The left side seat back support 20 is comprised of a larger tube 22 and a smaller tube 24. The right side seat back support 21 is comprised of a larger tube 26 and a smaller tube 28. The larger tubes 22 and 26, which are attached to the seat 10, slide onto the smaller tubes 24 and 28 when a user puts the seat in place. One reason for removing the seat is for transporting the bicycle. It is more easily stowed when the seat is removed. When the user wants to adjust the seat to make it a more comfortable fit, the person would simply slide larger tubes 22 and 26 up or down smaller tubes 24 and 28. This way the bicycle can comfortable accommodate users of varying heights. The tubes are anchored into place by a first clamp 31 and a second clamp 30.

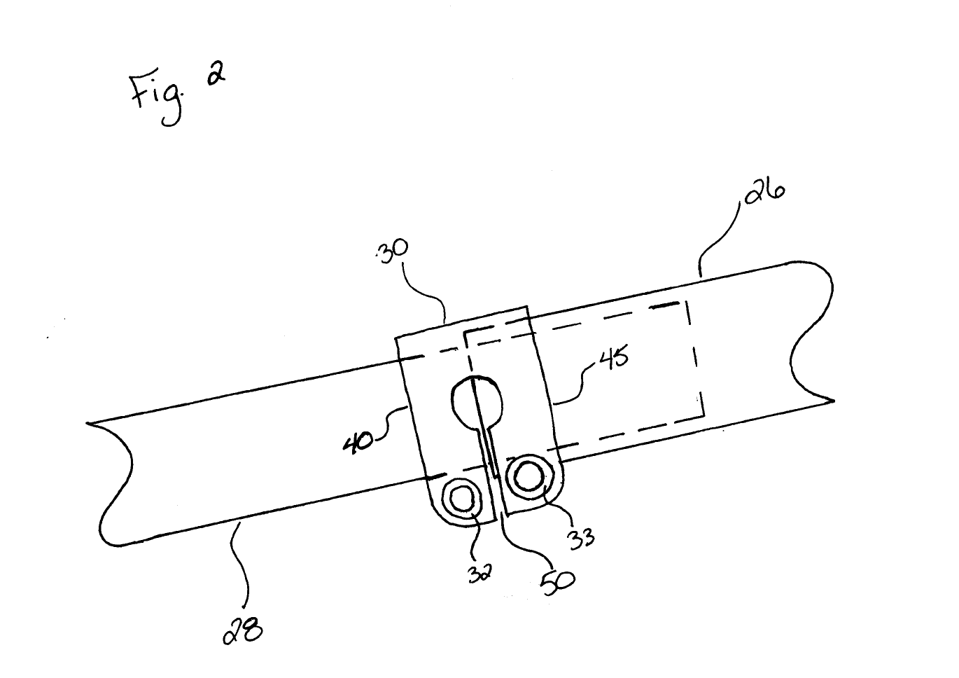

FIG. 2 shows a side view of the right seat back support 21 with right clamp 30 holding smaller tube 28 in place with larger tube 26. There are at least two scenarios that would lead the user to move the bicycle tubes. The first scenario is having to adjust the seat to accommodate users of different sizes. A user who is 6 feet tall will likely be comfortable with the seat in a different position than will a user who is 5 feet tall. Therefore, in order to accommodate a user of a different height, the user would simply loosen the clamp 30 and slide the larger tube 26 up or down the smaller tube 28. When the seat is at the desired position, the user can look through slot 50 of clamp 30 to see that the end of the larger tube 26 is securely in place. The slot 50 is equidistant from the first end 40 to the second end 45 and is perpendicular to a line drawn between the first end 40 and second end 45. Once the larger tube is visible in the middle of the slot, the larger tube is in a position on the smaller tube where it will be sturdy. This is as opposed to the larger tube only covering the smaller tube a few centimeters, making the tubes likely to bend under the pressure of a user's weight. Once the tubes are in place, bolts 32 and 33 can be tightened. Clamp 30 does not have any pins that must be removed during adjustments to the tubes, which obviates the possibility of losing any necessary pieces to hold the tubes in place.

The second scenario where the user would find it necessary to move the bicycle tubes is for transporting the bicycle. Because of the size of the overall bicycle, it is easier to transport the bicycle by taking the seat off and having it in two manageable pieces. The usual problem is that once the seat is put back in, the user has to take the time to adjust the bicycle tubes that support the seat in order to put the seat where it was before the seat was removed. This can be time consuming and there is the possibility of losing the pins during transportation, making it impossible to keep the seat sturdily on the bicycle without getting new pins. Clamp 30 in FIG. 2 can be permanently attached to the smaller tube 28 in the position that is desired when the user uses the bicycle. This way, once the seat and the larger tube 26 is removed for transportation purposes, the clamp 30 saves the positioning of the seat. When the user wants to put the seat back on the bicycle, the larger tube 26 is slid over the smaller tube 28. When the larger tube 26 slides over the smaller tube 28, it will slide into the second end 45 of the clamp 30. The user can be sure that the larger tube 26 is securely fastened on smaller tube 28 by seeing the end of the larger tube 26 through the slot 50. When the end of the larger tube 26 is visible through the slot 50, the tubes are securely in place. Bolts 32 and 33 should then be tightened, preferably with a 3mm Allen wrench, and the bicycle is ready to be ridden.

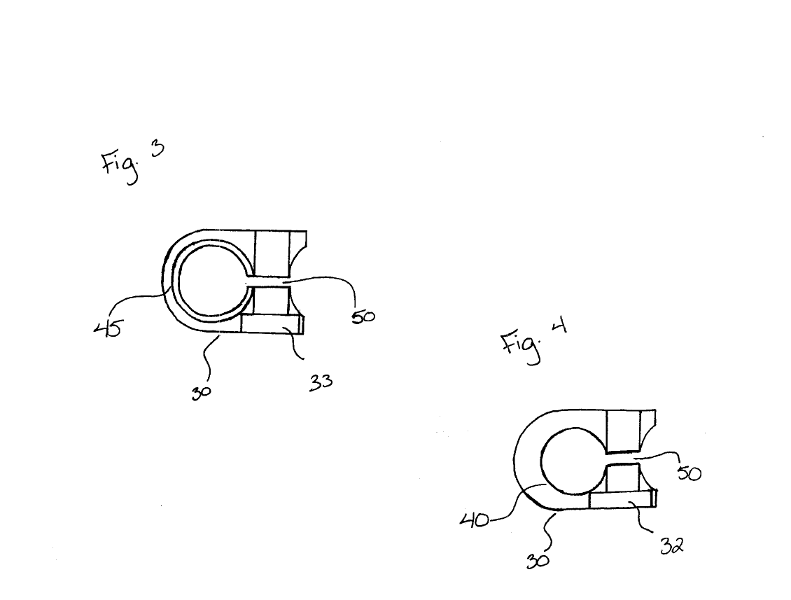

FIGS. 3 and 4 show a view of the bottom and top, respectively, of right clamp 30. Bolts 32 and 33 are tightened to hold left clamp 30 in place. The first end 40 is in line with the second end 45, although the openings are different sizes. The different sized openings allow for the smaller tube to fit into the first end and the larger tube to fit into the second end. The clamp can always be attached to the smaller tube so that the first end 40 is always engaged around the smaller tube in order to hold the position of the seat as it was last used. The second end 45 remains empty until the user replaces the large tube of the seat back support. The larger tube would then slide down the smaller tube until it reached the middle of the clamp, which would then prevent the larger tube from going down any further. This would allow the user to have the seat in the exact same position as before it was removed from the bicycle, thereby saving the setting of the seat position and obviating the need for the user to adjust the seat each time it is removed from the bicycle. The user can ensure that the larger tube is in a secure position over the smaller tube by looking through slot 50 to see that the end of the larger tube is visible through the slot 50. When the end of the larger tube is visible through slot 50, the bicycles tubes are secure and will not bend under the pressure of the weight of the user once the bicycle is in use.

1. An apparatus for securing a first larger tube and a second smaller tube to one another, comprising:
a main body;
a first end, on said main body, configured to receive the first larger tube;
a second end, on said main body, configured to receive the second smaller tube;
a slot on said main body; and
a first hole at a first end of said slot.

2. The apparatus of claim 1, wherein said first end is shaped like an arc.

3. The apparatus of claim 1, wherein said second end is shaped like an arc.

4. The apparatus of claim 1, wherein said first end and said second end are shaped like an arc.

5. The apparatus of claim 1, wherein said first end and second end are in line with one another.

6. The apparatus of claim 4, wherein said first end and said second end are in line with one another.

7. The apparatus of claim 1 further comprising a first tightening means on said first end.

8. The apparatus of claim 7, wherein said first tightening means is a first clamp.

9. The apparatus of claim 1, further comprising a second tightening means on said second end.

10. The apparatus of claim 9, wherein said second tightening means is a second clamp.

11. The apparatus of claim 6, wherein said first end has a first clamp and said second end has a second clamp.

12. The apparatus of claim 1, wherein said first hole is on a first side of said main body.

13. The apparatus of claim 12, wherein said slot is positioned on said main body perpendicular to a line, the line drawn between said first end and said second end.

14. The apparatus of claim 12, wherein said slot is equidistant from said first end and said second end.

15. The apparatus of claim 13, wherein said slot is equidistant from said first end and said second end.

16. The apparatus of claim 12, wherein said slot is configured to display an end of the larger tube.

17. The apparatus of claim 15, wherein said slot is configured to display an end of the larger tube.

18. The apparatus of claim 4, wherein the diameter of the arc of said first end is not equivalent to the diameter of the arc of said second end.

19. The apparatus of claim 12, further comprising a second hole at a second end of said slot on a second side of said main body.

20. The apparatus of claim 19, wherein said first hole and said second hole are circular.
